(19) United States
(12) Patent Application Publication
(10) Pub. No.: US 2003/0139983 A1
(43) Pub. Date: Jul. 24, 2003

(54) Method and system for integrated natural resource management

(76) Inventors: James Stanley Spencer, Nanaimo (CA); Terrance Ralph Earles, Vancouver (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/056,753

(22) Filed: Jan. 24, 2002

(51) Int. Cl. G06F 17/60

(52) U.S. Cl. 705/28

(57) ABSTRACT

In the present invention, there is provided a computer-implemented system for integrated natural resource management. The system is adapted to store and manage resource management information associated with defined geographic units in a database. This includes a unit for storing spatial information and non-spatial information associated with the defined geographic units. The system is also adapted for preparation of resource activity plans based on the resource management information for use in managing a natural resource within the defined geographic units. Also provided is a unit for tracking actual results of managing the natural resource according to the resource activity plans for use in updating the resource management information, as well as a unit for updating the resource management information based on the tracking of actual results.

### FIELD OF THE INVENTION

The present invention relates generally to natural resource management and more particularly to a computer-implemented method and system for integrated management of a natural resource.

### BACKGROUND OF THE INVENTION

Managing a natural resource for a large-scale operation can present to significant challenges. By way of example, complex resource management can involve many factors including capital equipment requirements, human capital requirements, budgetary requirements, government regulations, wildlife management, environmental quality, and resource availability.

Managing the natural resource can involve planning for the development and maintenance of infrastructure needed for resource extraction and delivery.

Further planning is needed for actual extraction and delivery of the natural resource. Large-scale operations can involve third party contractors in order to support the management of the natural resource. Such contractors also need to be managed in an efficient and effective manner in order to plan and execute the extraction and delivery of the natural resource. Such contractors and the relationships with such contractors may need to be tracked and managed, including the allocation of such resources, their availability, and the compensation for their services.

It would be desirable to have a system which provides an integrated solution to natural resource management. It would be further desirable to have a system for resource management which is capable of providing an automated mechanism for planning the management of a natural resource as well as for tracking the actual results of such management.

### SUMMARY OF THE INVENTION

In accordance with one aspect of the present invention, there is provided a computer-implemented natural resource management system that provides an integrated system for managing a natural resource. A computer-implemented system is provided for integrated natural resource management. The system comprises means for storing and managing resource management information associated with defined geographic units in a database. This includes means for storing spatial information and non-spatial information associated with the defined geographic units. The system also includes means for preparing resource activity plans based on the resource management information for use in managing a natural resource within the defined geographic units. Also provided is means for tracking actual results of managing the natural resource according to the resource activity plans for use in updating the resource management information, as well as means for updating the resource management information based on the tracking of actual results. The system promotes improved collection, planning, analysis, and sharing of data to assist with natural resource management. The system can also help an organization meet its stewardship commitments in relation to the natural resource being managed.

In accordance with another aspect of the present invention, a computer-implemented system for integrated natural resource management comprising a resource management information system, a resource activity planning system, an actual results tracking system and a product inventory management system. The resource management information system is adapted to store and manage resource management information associated with defined geographic units in a database, including spatial information and non-spatial information associated with the defined geographic units. The resource activity planning system is adapted to prepare resource activity plans based on the resource management information for use in managing a natural resource within the defined geographic units. The actual results tracking system is adapted to track actual results of managing the natural resource according to the resource activity plans for use in updating the resource management information. The product inventory management system is adapted to store harvested inventory movement results received from the actual results tracking system. In this embodiment the resource management information system is also adapted to update the resource management information based on the tracking of actual results by the actual results tracking system.

In accordance with another aspect of the present invention, a computer-implemented natural resource management system integrates resource management information for a natural resource with planning activities associated with the management of the natural resource and with the actual tracking of the progress of planned activities. The resource management information comprises computer-represented characteristics of the natural resource, such as spatial and non-spatial attributes, which are managed in the system using one or more computer-readable databases. The computer-represented characteristics provide a profile of the natural resource including inventory characteristics and characteristics of the land base upon which the natural resource exists. Spatial attributes are used in the system to specify geographic aspects of the natural resource such as location. Non-spatial attributes provide information about geographic aspects which are not defined by the spatial attributes. Non-spatial attributes include, by way of example, estimated volume of the natural resource available within one or more defined geographic units. Spatial and non-spatial attributes are used within the resource management system to prepare computer-generated plans for the harvesting and management of the natural resource from defined geographic units. Computer-readable representations specify the characteristics of defined geographic units and correspond to known information with respect to actual geographic regions over which a natural resource is to be managed using the natural resource management system. Integrating results tracking into the natural resource management system enables one to evaluate the effectiveness of planning and to more rapidly adapt resource management to expected and unexpected changes to the resource inventory and the human and capital resources available to supporting resource management. Results tracking also enables one to adapt resource management to improve future planning based on the results of executed plans and activities.

Integrating funding sources, human and capital equipment sources, attributes of the land base and the natural resource, with regulatory and non-regulatory constraints provides a system with which natural resource management can be more easily and effectively carried out.

Other aspects and features of the present invention will become apparent to those ordinarily skilled in the art upon review of the following description of specific embodiments of the invention in conjunction with the accompanying drawings.

### BRIEF DESCRIPTION OF THE DRAWINGS

In drawings which illustrate embodiments of the invention,

FIG. 1 is a block diagram illustrating the natural resource management system in accordance with a first embodiment of the invention;

FIG. 2 is a block diagram illustrating another view of the natural resource management system in FIG. 1;

FIGS. 3 to 9 are flow diagrams illustrating the operation of the natural resource management in FIG. 1; and

FIG. 10 is a block diagram illustrating an other embodiment a natural re source management system in accordance with the present invention.

### DETAILED DESCRIPTION

Reference will now be made in detail to implementations and embodiments of the invention, examples of which are illustrated in the accompanying drawings.

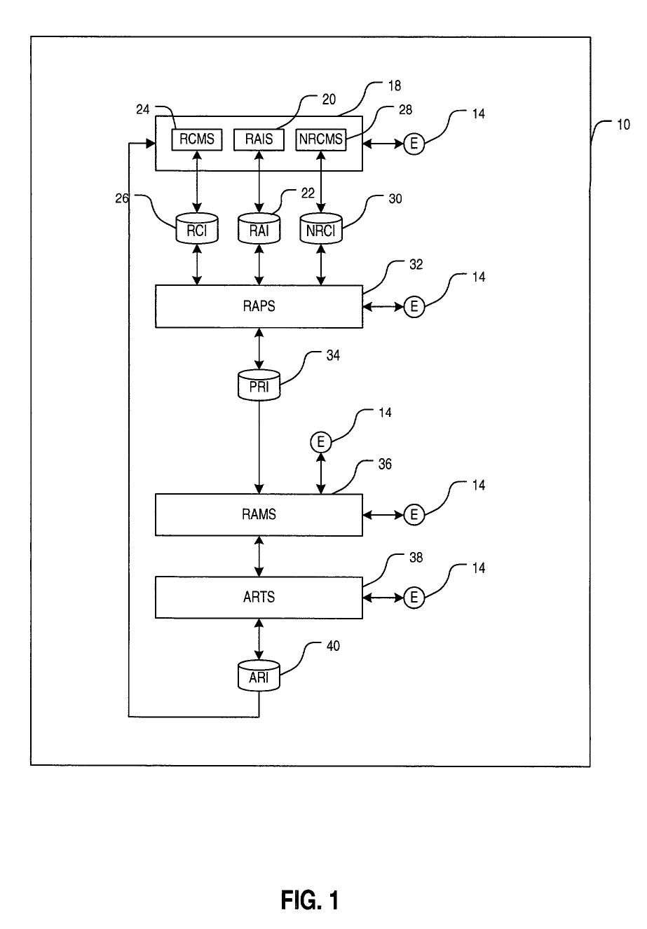

Referring to FIG. 1, a natural resource management system according to a first embodiment of the invention is shown generally at 10.

The natural resource management system (NRMS) 10 provides an integrated system for managing and monitoring a natural resource and a plurality of factors which affect the management of the natural resource such as the condition and attributes of the associated land base and of the natural resource, regulatory and non-regulatory constraints affecting natural resource management, available human and capital resources for managing the natural resource, including contractors and contractor equipment, and available funding and budgetary constraints.

The natural resource management system 10 also provides a mechanism for monitoring (tracking) performance and for adjusting to changes in conditions which result in actual results differing from planned results. By tracking actual results, the natural resource management system 10 is able to provide an improved capability for complying with regulatory constraints and non-regulatory constraints both at the outset of planning and during execution of planned activities associated with managing the natural resource.

In the first embodiment shown in FIG. 1, the natural resource management system 10 manages resource management information associated with one or more defined geographic units. With the natural resource management system 10, resource activity plans are prepared based on the characteristics of the resource management information. The resource activity plans are used to plan and direct activities associated with managing the natural resource. The natural resource management system 10 also tracks actual results of executed plans. Feedback from the tracking of actual results is used to adapt the stored resource management information and resource activity plans to changing conditions relating to the management of the natural resource.

In this specification, “resource management information” refers broadly to computer-readable information used for supporting management of the natural resource. Data structures are used to store the resource management information within the natural resource management system 10. As discussed further below, resource management information includes a variety of types of information that are managed by the natural resource management system 10. For instance, resource management information includes resource attribute information, regulatory constraint information, and non-regulatory constraint information. Resource attribute information represents spatial and non-spatial information about the one or more defined geographic units managed by the natural resource management system 10. Regulatory constraint information represents information pertaining to governmental laws and regulations applicable to the defined geographic units under management. For example, in the context of forestry resource management, regulatory constraint information includes, by way of example, stumpage rates, allowable harvest rates, and volumes depending on forest inventory. Non-regulatory constraint information represents non-regulatory constraints relevant to planning resource activities associated with managing the natural resource within the defined geographic units.

Defined geographic units are computer-readable representations of defined portions of a land base within which the natural resource is managed using the natural resource management system 10. By way of example, a natural resource managed by the natural resource management system 10 may be a timber resource, a mineral resource, an ore, oil, natural gas, water, or another natural resource which may be harvested. Broadly speaking, the terms “harvest” and “harvesting” as used in this specification refer to the gathering of a natural resource associated with one or more defined geographic units. Depending on the nature of the natural resource that is being managed by the natural resource management system 10, harvesting will involve one or more aspects. For instance, in the context of mining, harvesting includes the extraction of the mineral or ore resource. When the natural resource under management is oil or natural gas, then harvesting includes the gathering and transmission of that natural resource.

For the first embodiment, the natural resource is a timber resource and the natural resource management system 10 is configured for use in the forest industry. Defined geographic units in this embodiment are computer-readable representations of portions of a land base known in the forest industry as “blocks”.

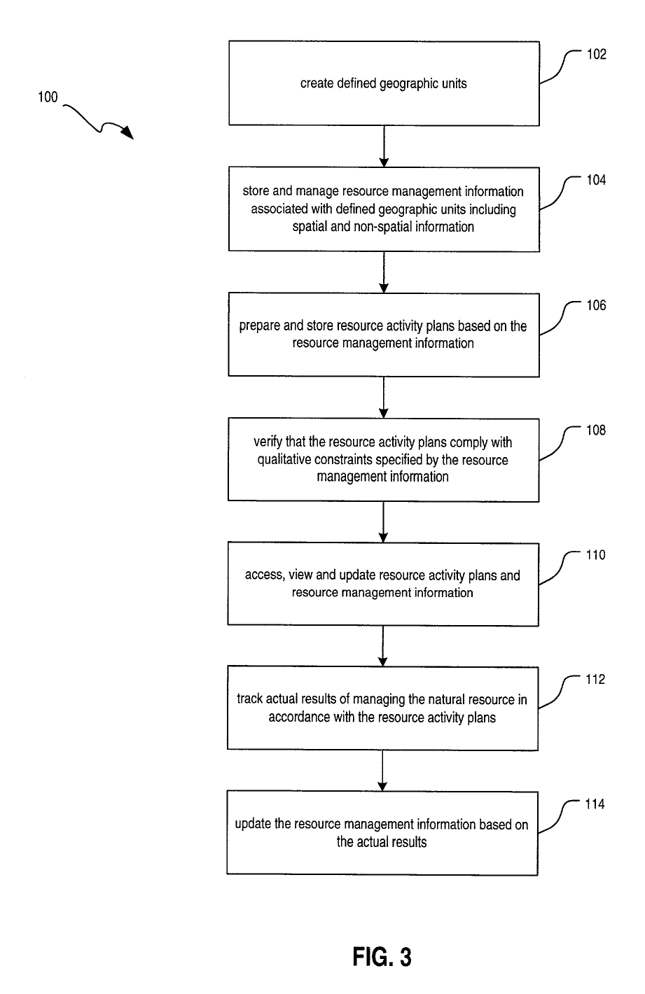

In the first embodiment shown in FIG. 1, the natural resource management system (NRMS) 10 includes a resource management information system (RMIS) 18, a resource activity planning system (RAPS) 32, a resource activity management system (RAMS) 36 and an actual results tracking system (ARTS) 38. The operation of the natural resource management system 10 is shown generally at 100 in FIG. 3. In general, the resource management information system 18 stores and manages at step 104 the resource management information used in the planning process with the resource activity planning system 32. Information managed by the resource management information system 18 is stored in one or more databases which, in the first embodiment, include a resource attribute information database 22, a regulatory constraint information database 26, and a non-regulatory constraint information database 30. The resource activity planning system 32 provides a system for preparing plans associated with managing the natural resource at step 106. The resource activity planning system 32 relies on the resource management information managed by the resource management information system 18 to support the preparation of resource activity plans. Preferably, at step 108 the resource activity planning system 32 compares resource activity plans with qualitative constraints specified by the resource management information managed by the resource management information system 18 to verify that the resource activity plans comply with such constraints and can be performed as planned. Resource activity plans are stored in a planned results information database 34 for use by the resource activity management system 36 to provide users with views of planned results at step 110 and for comparison with actual results of planned activities tracked by the actual results tracking system 38 at step 112. Actual results stored by the actual results tracking system 38 are used at step 114 to update the resource management information managed by the resource management information system 18 to reflect changes in conditions in properties of the natural resource and the management thereof.

The natural resource management system 10 provides integrated supply chain management support for a natural resource, from computerized management of resource management information such as initial attributes of the land base and natural resource, to integrated planning for infrastructure, harvesting and post-harvesting reclamation, to tracking of actual results of planned activities which are used as feedback to update the resource management information for improved accuracy of resource activity planning and management of the natural resource.

Operating Environment

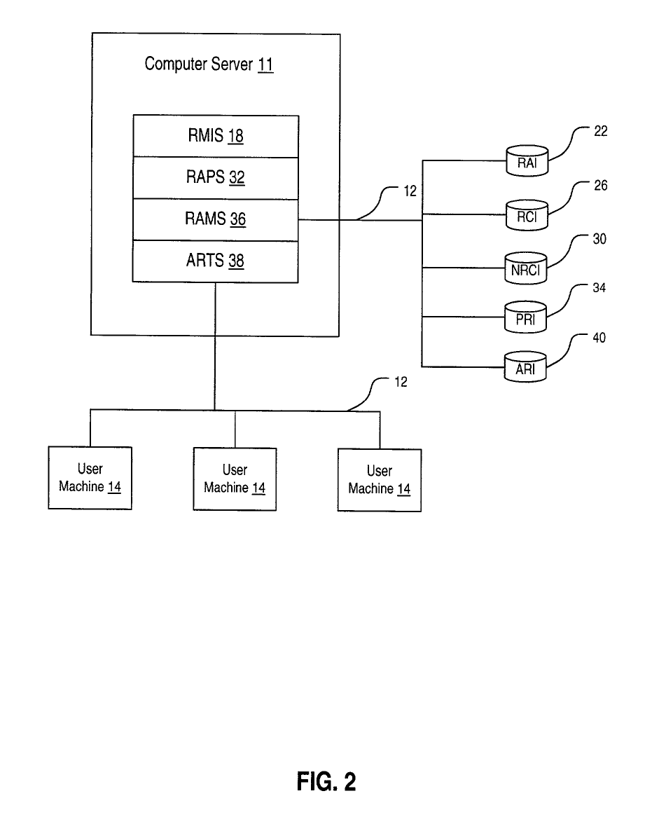

Referring to FIG. 2, the natural resource management system 10 is implemented as software programmed to run on one or more computer servers 11 connected via a network 12. Information associated with the natural resource is stored in databases (for example, databases 22, 26, and 30) used by the natural resource management system 10. The databases used by the natural resource management system 10 may be implemented using any of a variety of conventional databases such as Oracle™ or another database system suitable for the management of large amounts of data. Such databases can reside on one or more data storage media, such as a hard disk drive or re-writtable optical disk drive.

In the first embodiment, the network 12 used to support the natural resource management system 10 is an Ethernet based local area network (LAN). It will be appreciated by persons skilled in the art, however, that the network upon which the natural resource management system 10 operates may be one of a variety of network infrastructures. For instance, the network 12 may be another type of LAN, such as a token ring LAN. Alternatively, the network 12 may be a wide area network (WAN). In yet another variation, the network 12 may be an internetworked combination of several network topologies. A user or operator communicates with the natural resource management system 10 via a user machine 14 or another computer system capable of communicating with the natural resource management system 10. In the first embodiment, the user machines 14 are personal computing devices which are programmed with a user interface through which users communicate with the natural resource management system 10. Examples of commercially available software which can be used to provide user interfaces are Powerbuilder™ and web browsers such as Netscape Navigator™, Microsoft Internet Explorer™ and Mosaic™. Connections between user machines 14 and the natural resource management system 10 are provided over a computer network using a TCP/IP protocol in the first embodiment, although other communications protocols may be used.

Preferably, the hardware architecture for the natural resource management system 10 is scalable to meet the needs of the system 10.

Resource Management Information System

Referring to FIGS. 1 and 3, defined geographic units are created and stored by the resource management information system 18 at step 102. Users access the resource management information system 18 via user machines 14 to create and modify the defined geographic units. The resource management information system 18 is also used to store and manage resource management information associated with defined geographic units at step 104. Resource management information is captured and stored in one or more databases managed by the resource management information system 18. Such resource management information may be entered into the resource management information system 18 via one or more of the user machines 14.

In the first embodiment, the resource management information system 18 contains a resource attribute information system (RAIS) 20, a regulatory constraint management system (RCMS) 24 and a non-regulatory constraint management system (NRCMS) 28.

The resource attribute information system 20 manages a resource attribute information database 22 which is used to store resource attribute information such as spatial information and non-spatial information characterizing the defined geographic units managed by the natural resource management system 10. Information stored in the resource attribute information database 22 is dynamically updated by the resource attribute information system 20 in response to feedback from the actual results tracking system 38.

Spatial information is used to define map coordinates of a defined geographic unit to support the computerized display of maps for the defined geographic units with the natural resource management system 10. Spatial information associated with a defined geographic unit can be recorded and stored within the resource attribute information database 22 in various ways. In the first embodiment, a polygon is used to define a representation of spatial information (“spatial data”) for a defined geographic unit. Such spatial information may be already in computer-readable form and imported from the third party source, or it may be collected, digitized and then uploaded into the resource attribute information database 22. This may be done with a user machine 14 or another computer system in communication with the resource attribute information system 20. For example, with the forestry application in the first embodiment, one method of collecting such spatial information is to have the actual land base associated with the defined geographic unit traversed with a geographic positioning satellite (GPS) equipment so as to record the GPS coordinates. These GPS coordinates can then be uploaded as data into the resource attribute information database 22 and associated with other resource management information stored in the natural resource management system 10 with respect to the corresponding defined geographic unit.

Non-spatial information is used by the natural resource management system 10 to characterize non-spatial features of the defined geographic units and the natural resource under management, including statistical information and ecological data. In the first embodiment, the resource management information system 18 is programmed to associate non-spatial information with spatial information based on user-initiated commands. The user 10 accesses a digital map of a defined geographic unit from the resource management information system 18 via a user machine 14 and selects a portion of the map that is to be characterized by non-spatial information. Non-spatial information is then entered manually or uploaded to the resource management information system 18, assigned to the selected portion of the map, and stored in the resource attribute information database 22. Existing non-spatial information within the natural resource management system 10 can also be associated with a defined geographic unit in a similar manner.

Statistical information associated with the natural resource located on the defined geographic units can be entered or imported using the resource attribute information system 20 and forms part of the resource attribute information managed. To the extent such statistical information is already available electronically, it may be imported into the resource attribute information system 20. Statistical information can also be manually entered via a user machine 14 connected so as to interface with the resource attribute information system 20.

In the first embodiment, statistical information associated with the timber resource includes computer-readable data representing a “cruise”. In forestry, the sampling survey on a defined geographic area is called a cruise. The cruise is a statistical measure capturing the species, quantities and sizes of the trees in a sample area, in this case, a defined geographic unit. Analysis of the cruise is called a cruise compilation and this is used to infer the species and sizes of the trees in the defined geographic unit. In certain cases, cruise data may not be available or might be only partially available for recordal within the resource attribute information database 22. In such cases, the resource attribute information system 20 is programmed with the ability to receive and record estimates of the types of trees available on a defined geographic unit and to use the estimate in place of unavailable cruise data. Such estimated information gives planners estimates of the types of trees that are available for harvest in a defined geographic unit. Statistical information with respect to the timber resource can be matched up with the types of trees required for manufacturing sites or customers. Quantitative statistical information such as the quantity and size of each species of trees is also used by the resource activity planning system 32 to verify that resource activity plans can be performed as planned. In the first embodiment, cruise data stored within the resource attribute information database 22 includes industry standard classification of species within the defined geographic unit, the number of trees of each classified species within the defined geographic unit, estimated percentage of decay in the trees of each species, average diameter of the trees of each species, and percentage of trees of each species that have insect damage.

Ecological data associated with the defined geographic units is also entered into the resource attribute information system 20 for storage in the resource attribute information database 22. Ecological data stored in the resource attribute information database 22 is organized according to ecological units. An ecological unit is a computer-readable data set that groups ecological data pertaining to all or a portion of a defined geographic unit such as soil characteristics, growing conditions, and information about the climatic zone and terrain. Ecological units can be accessed by a user for review and are used in preparing resource activity plans with the resource activity planning system 32. In the first embodiment, information such as the percentage of bedrock, cobble, decayed wood, organic growth, and water in an ecological unit are stored within the resource attribute information database 22. Other ecological information stored in the resource attribute information database 22 includes classification information classifying the stability of the terrain of the ecological unit, classification of the drainage of the soil for the ecological unit, an identification of a party that conducted a survey on the ecological unit, and when the ecological unit survey was conducted. Soil characteristics stored include a classification of the soil, the state of organic decomposition of the soil layer for an ecological unit, minimum and maximum depths to ground water, minimum and maximum gleying depths, minimum and maximum bedrock depths, and minimum and maximum depths to compact soil.

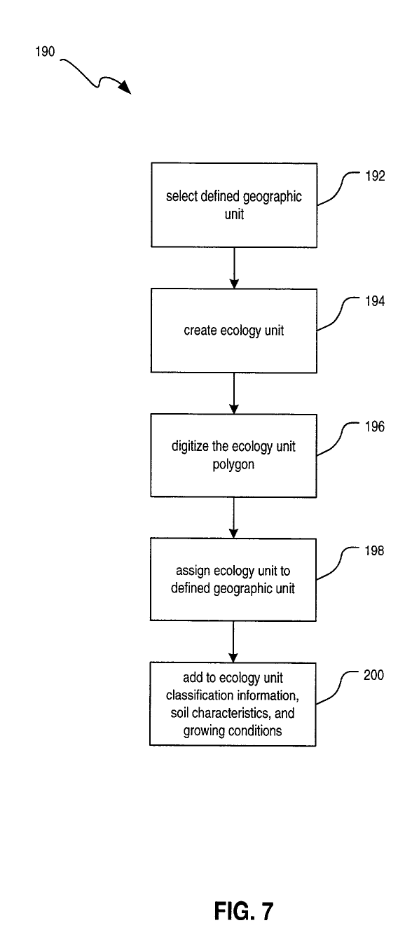

Referring to FIGS. 1 and 7, as shown generally at 190 the resource management information system 18 is programmed to create ecological units for use in preparing resource activity plans and for use in monitoring and verifying compliance with regulatory constraint information such as the silviculture prescriptions discussed in further detail below. To create an ecological unit, a user selects via a user interface a defined geographic unit from the resource management information system 18 at step 192 and initiates creation of an ecological unit at step 194. The spatial information for the ecological unit is entered into the resource management information system 18 at step 196 as a digitized polygon. The ecological unit is assigned to the selected defined geographic unit at step 198 and the classification information, soil characteristics, growing conditions and the like for the ecological unit are entered manually or uploaded at step 200.

In one variation, the resource management information system 18 may be used to manage one or more operating areas and one or more supply blocks.

An “operating area” is used to identify a select group of defined geographic units marked for similar management responsibilities. For instance, an operating area can represent a company-defined grouping indicating each of the defined geographic units under management by a particular company. A “supply block” is used to identify defined geographic units that have similar natural resource attributes. For instance, a supply block may be used to identify a family of defined geographic units containing similar timber attributes in the first embodiment. Such non-spatial information can be used to assist in preparing harvest plans and other plans associated with harvesting a particular timber resource available on a plurality of defined geographic units.

Regulatory Constraint Information

Referring to FIG. 1, the regulatory constraint management system 24 manages a regulatory constraint information database 26 which contains regulatory constraint information pertaining to governmental laws and regulations such as stumpage rates, allowable harvest rates, and volumes depending on forest inventory. Information stored in the regulatory constraint database 26 is automatically updated by the regulatory constraint management system 24 in response to feedback from the actual results tracking system 38, changes to the resource attribute information database 22, and inputs from the external world such as user-defined modifications to the regulatory constraint information.

In the first embodiment regulatory constraint information includes one or more silviculture prescriptions. A silviculture prescription is a government regulated set of constraints that describe the forest management objectives for a defined geographic unit. A silviculture prescription identifies government guidelines for harvesting the existing natural resource, and a series of silviculture treatments that will be carried out to establish growing a crop of trees in a manner that accommodates government guidelines and other conservation guidelines that a company may adopt. Other resource management activities managed by the natural resource management system 10 are monitored to comply with the standards stated within the silviculture prescription. For instance, harvest plans are prepared so as to meet the standards of the silviculture prescription. Table 1 below sets out, by way of example, attributes managed by the natural resource management system 10 in order to comply with a silviculture prescription.

TABLE 1

| | |
|---|---|
| Silviculture | A silvicultural system is a planned program of treatments |
| System | throughout the life of a stand of timber to achieve stand |
| | structural objectives based on integrated resource |
| | management goals. A silvicultural system includes |
| | harvesting, regeneration and stand-tending methods or |
| | phases. |
| Silviculture | A silvicultural variant further describes the attributes of a |
| Variant | silvicultural system. A variant describes the general |
| | distribution of cut-and-leave areas or trees left on an area |
| | over time. The variant indicates whether reserve trees are |
| | being retained on-site for long-term non-regeneration |
| | objectives, and whether these reserves are relatively |
| | uniformly distributed single trees, distinct groups or a |
| | mix of both. |
| Silviculture | Description of a specific harvest to extract merchantable |
| Phase | timber and achieve a specific silvicultural treatment. These |
| | include regeneration cuts and salvage cuts. The silviculture |
| | or “cut” phase indicates, to a degree, the timing of the cut |
| | within the prescription. |
| Current | Pre-harvest timber stand structure, which may be |
| Stand | expressed in numbers of stems and basal area by diameter |
| Structure/ | classes. |
| Site | |
| Conditions | |
| Leave Tree | Description of the species, function and characteristics of |
| Specifi- | any trees to be left standing after harvesting. |
| cations | |
| Minimum | Minimum planned basal area to be retained after |
| Residual | harvesting. Basal area is the cumulative cross sectional |
| Basal Area | area of trees as measured at breast height. |
| Minimum | Minimum planned stand density to be retained after |
| Residual | harvesting. |
| Density | |
| Management | The management objectives for the area that are subject to |
| Objectives | the silviculture prescription. |
| Post Harvest | Identification of forest resource values and features within |
| Site | the prescription area and description, on a site-specific |
| Conditions | basis, of the action to be taken to accommodate them. |
| | Accommodations may be made through modification of |
| | harvest boundaries or methods, or through the use of a |
| | particular silvicultural prescription, stocking standards, |
| | species selection, site preparation, brushing or stand- |
| | tending treatments. |
| | Forest resource values and features include wildlife, |
| | fisheries, watershed values, recreation, visual values, |
| | cultural heritage resources, and ranges. |
| Riparian | User defined identification for the riparian area. Riparian |
| Identification | areas occur next to the banks of streams, lakes, and |
| | wetlands and include both the area dominated by |
| | continuous high moisture content and the adjacent upland |
| | vegetation that exerts an influence on it. |
| Riparian | Government defined grouping of steams, lakes and |
| Class- | wetlands based on similar attributes. |
| ification | |
| Minimum | Minimum basal area in the riparian management area. |
| Riparian | |
| Basal Area | |
| Minimum | Minimum stand density in the riparian management area. |
| Riparian | |
| Density | |
| Riparian | Size of the riparian reserve zone. This is the area from the |
| Reserve | boundary of the stream, lake, or wetland to the riparian |
| Zone | management zone. Harvesting is not permitted in this |
| | zone. |
| Riparian | Size of the riparian management zone. This is the area |
| Management | starting from the riparian reserve zone to the boundary of |
| Zone | the riparian management area. Constraints to harvesting |
| | are applied to this zone to conform with government- |
| | provided requirements. |
| Management | Description of management strategies for gullies, forest |
| Strategies | health, coarse woody debris, archaeological sites, and |
| | vegetation management. |
| Proportion of | Maximum proportion, if any, of the total area under the |
| total area | prescription that may be occupied by roads, landings, |
| occupied by | gravel pits, permanent logging trails, and other permanent |
| permanent | access structures. |
| access | |
| structures | |
| Temporary | The planned area to be taken up by temporary access |
| Access | structures on a defined geographic unit. Temporary access |
| Structure | structures include those haul roads, landings and |
| Area | excavated or bladed trails that will be restored to a |
| | productive state upon completion of harvesting. |
| Temporary | The location of the temporary access structure in the |
| Access | defined geographic unit. |
| Structure | |
| Location | |
| Temporary | The types of equipment that will use the temporary access |
| Access | structure while the defined geographic unit is in use. |
| Structure | |
| Equipment | |
| Temporary | The maximum time estimated to complete rehabilitation, |
| Access | measured from the time harvesting is complete. |
| Structure | |
| Maximum | |
| Rehab- | |
| ilitation | |
| Time | |
| Maximum | The maximum height of cutbanks for excavated or bladed |
| Bank Height | trails. |
| Average | The average height of cutbanks for excavated or bladed |
| Bank Height | trails. |
| Slope | Any indicators of potential slope instability. |
| Instability | |
| Indicator | |
| Prepared by | Person who prepared the silviculture prescription. |
| Submission | Date the silviculture prescription was submitted. |
| Date | |
| Approved | Date the silviculture prescription was approved by a |
| Date | government regulatory authority. |

The regulatory constraint management system 24 also captures and manages standards units. A “standards unit” refers to an area or areas of one or more defined geographic unit(s) in which a silvicultural prescription, including stocking standards and soil conservation standards, is uniformly applied. Certain trees will only grow in certain soil conditions. A standards unit is an example of relating one or more ecology units to restocking information and other regulatory constraint information so that resource activity plans are carried out in compliance with regulatory guidelines. An example of the attributes managed within a standards unit by the regulatory constraint management system 24 are set forth below in Table 2.

TABLE 2

| | |
|---|---|
| Standards | User defined name for the standards unit. |
| Unit | |
| Identification | |
| Standards | Description of the standards unit. |
| Unit | |
| Description | |
| Standards | Grouping of standards unit. |
| Unit Type | |
| Standards | Total area of the standards unit. |
| Unit Area | |
| Soil | Hazard rating of soil compaction in the standards unit. Soil |
| Compaction | compaction is the increase in soil bulk density that results |
| | from the rearrangement of soil particles in response to |
| | applied external forces. |
| Surface Soil | Hazard rating of surface soil erosion in the standards unit. |
| Erosion | Soil erosion is the wearing away of the earth's surface by |
| | water and wind. |
| Soil | Hazard rating of soil displacement in the standards unit. |
| Dis- | Soil displacement is the mechanical movement of soil |
| placement | materials by equipment and logs. |
| Maximum | The maximum proportion, if any, of the standards unit that |
| Allowable | may be occupied by soil disturbance as a result of |
| Soil | harvesting, silviculture treatments or hazard abatement |
| Disturbance | activities. |
| Extent Soil | The maximum proportion, if any, that soil disturbance |
| Disturbance | limits may be temporarily exceeded to construct temporary |
| Temporarily | access structures within the standards unit. |
| Exceeded by | |
| Temporary | |
| Access | |
| Structure | |
| Unfavour- | The type of unfavourable subsoil. Unfavourable subsoils |
| able | are those that produce unfavourable growing conditions |
| Subsoil Type | when exposed by displacement. |
| Sediment | The risk of sediment delivery to streams if temporary |
| Delivery | access structures are proposed. |
| Risk | |
| Minimum | The minimum depth to unfavourable subsoil in the |
| Depth to | standards unit, if temporary access structures are |
| Unfavour- | proposed. |
| able | |
| Subsoil | |
| Maximum | The maximum depth to unfavourable subsoil in the |
| Depth to | standards unit, if temporary access structures are |
| Unfavour- | proposed. |
| able | |
| Subsoil | |

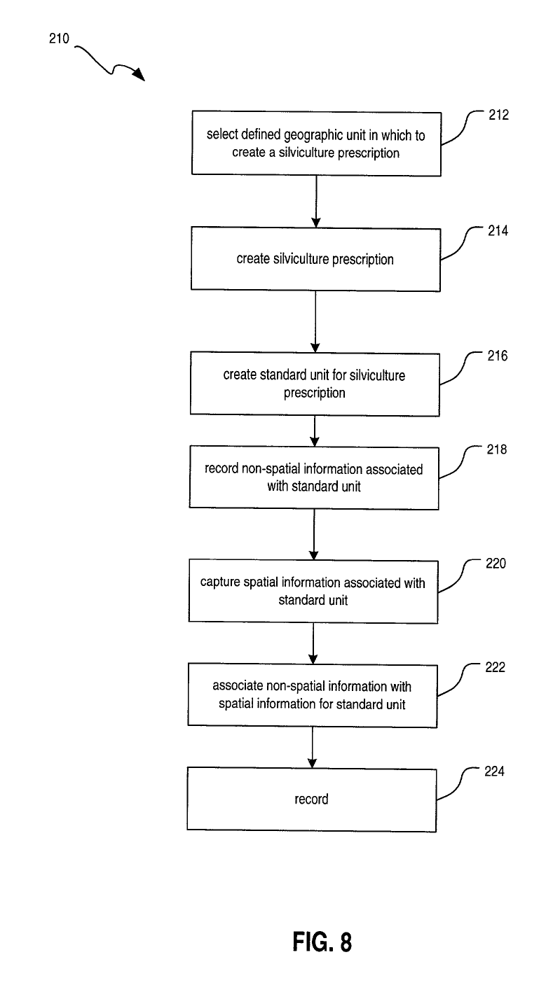

Referring to FIGS. 1 and 8, creation and storage of a silviculture prescription and a standard unit are shown generally at 210. At step 212, the user accesses the regulatory constraint management system 24 via a user interface and selects a defined geographic unit in which to create a silviculture prescription at step 214. The attributes set out earlier in Table 1 are entered for the silviculture prescription at step 214. A standard unit for the silviculture prescription is created with the regulatory constraint management system 24 at step 216 including entering the coordinates (spatial information) for the standard unit in relation to one or more defined geographic units. Such spatial information can be entered manually such as by selecting with a mouse or other input device portions of graphical representations of defined geographic units displayed on a user interface. Alternatively, such spatial information may be uploaded in a pre-generated, computer-readable format. Non-spatial information contained in the silviculture prescription is associated with the standard unit at step 220. The silviculture prescription and associated standards unit are recorded and stored by the regulatory constraint management system 24 at step 224.

Non-Regulatory Constraint Information

The non-regulatory constraint management system 28 manages a non-regulatory constraint information database 30 which contains non-regulatory constraint information relevant to planning resource activities. For example, the non-regulatory constraint information database 30 may be used to track company business objectives or customer product inventory requirements for reference in the resource activity planning system 32. Information stored in the non-regulatory constraint database 30 is automatically updated by the non-regulatory constraint management system 28 in response to feedback from the actual results tracking system 38, changes to the resource attribute information database 22, and inputs from the external world such as user-defined modifications to the non-regulatory constraint information.

Identification of Infrastructure

In order to harvest a natural resource, existing infrastructure available to support such harvesting needs to be identified. The resource attribute information system 20 is used to record and store infrastructure elements within the resource attribute information database 22. Infrastructure elements are computer-readable representations of real-world infrastructure which can include roads, bridges, culverts, railway crossings, and other types of man-made structures. For example, in the context of natural gas, infrastructure includes gas pipelines. In the case of water, infrastructure includes dams and related facilities. Infrastructure elements stored within the natural resource management system 10 form part of the resource management information.

An infrastructure element is represented by one or more data structures which contain infrastructure attributes. Infrastructure attributes are used to store information that characterizes properties of an infrastructure element, such as spatial and non-spatial information. Spatial information associated with an infrastructure element provides for the location of such infrastructure element within the one or more defined geographic units. Non-spatial information represents information associated with the infrastructure element but which is not necessarily specific to a map coordinate.

Infrastructure attributes are used by the natural resource management system 10 to assist in the planning and management of harvesting and post-harvesting reclamation. Infrastructure attributes can also be used to monitor the condition of infrastructure elements available to support such planning and management. By way of example, infrastructure attributes may be stored for roads used to support resource management within the defined geographic units. In the first embodiment, stored infrastructure attributes which represent non-spatial information for a road include the classification of the road (for example, a fire guard, forestry road, operational road, or a highway), speed limit, seasonal availability of the road, road status (active, inactive, under plan, or approved), road width, radio frequency band (i.e. the radio channel and frequency used on the road), the percentage slope of the road, if any, the related harvest permit number if applicable, the related road permit number if applicable, approximate percentage of rocks on the road, and the hazard rating of the road.

As indicated earlier, the resource attribute information, regulatory constraint information, non-regulatory constraint information, and information about infrastructure elements are entered into the resource management information system 18 via one or more of the user machines 14. Such information may also be submitted or uploaded in computer-readable form from another computer system (not shown) connected in communication with the resource management information system 18 or another component of the natural resource management system 10 in communication therewith.

The resource management information stored in the resource attribute information database 22, the regulatory constraint information database 26, and the non-regulatory constraint information database 30 provide a knowledge base with which resource activity plans can be prepared using the resource activity planning system 32. With the resource management information system 18, users can view resource management information, both qualitative and quantitative, to assist with planning activities using the resource activity planning system 32, to verify the viability of a resource activity plan based on resource attribute information associated with a particular defined geographic unit, and to verify compliance with regulatory constraints managed by the regulatory constraint management system 24.

In the first embodiment, the resource management information is shown being stored within three separated databases. It will be appreciated by persons skilled in the art that other configurations may also be used. For instance, a single database or a plurality of databases may be used to store such information. The resource management information is shown stored in separate databases in the first embodiment to underscore its multiple contributions to the role of the resource activity planning system 32. As well, although the databases 22, 26, and 30 are managed by the resource attribute information system 20, the regulatory constraint management system 24, and the non-regulatory constraint management system 28, these systems may be integrated with each other or implemented as part of one unified and overarching resource management information system for the management of the information within databases 22, 26, and 30.

Resource Activity Planning System

The resource activity planning system 32 provides a system for preparing plans associated with managing the natural resource (i.e. “resource activity plans”). The resource activity planning system 32 relies on the resource management information managed by the resource management information system 18 to support the preparation of the resource activity plans including information stored in the resource attribute information database 22, the regulatory constraint information database 26 and the non-regulatory constraint information database 30.

Users prepare and access such plans by communicating with the resource activity planning system 32 via user machines 14. In the first embodiment, computer-readable forms for preparing plans are presented to users by the resource activity planning system 32 via a user interface on the user machines 14.

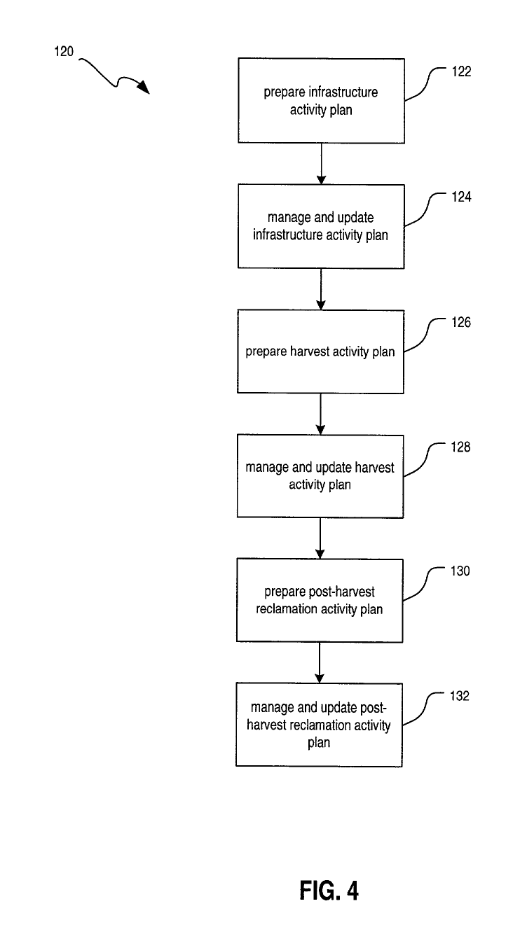

In the first embodiment, the resource activity planning system 32 provides a mechanism for preparing and managing infrastructure activity plans, harvesting activity plans, and post-harvesting reclamation activity plans, as illustrated in FIG. 4. Operation of the resource activity planning system 32 is described in further detail below.

Infrastructure Planning

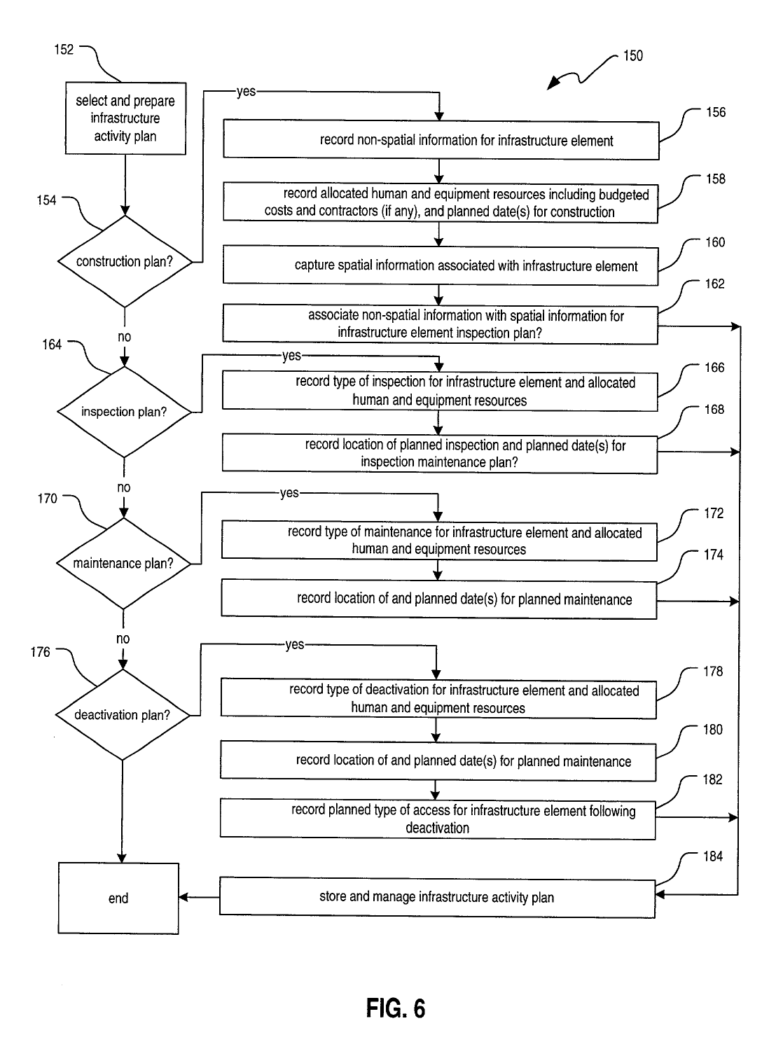

Referring to FIGS. 1 and 6, in order to harvest the natural resource, existing infrastructure available to support such harvesting needs to be identified and maintained. As well, plans need to be put in place for creating new infrastructure where necessary. With the resource activity planning system 32, one or more infrastructure activity plans can be prepared as illustrated generally at 150. Infrastructure activity plans are used to plan for the construction (154), inspection (164), maintenance (170), deactivation (176), access control (not shown) and the like, of infrastructure elements used in accessing, harvesting, and reclamation of the natural resource within the defined geographic units.

To prepare an infrastructure activity plan, a user accesses the resource activity planning system 32 and selects the type of infrastructure activity plan that is to be prepared (for instance, a plan for the construction, inspection, maintenance, or control of one or more infrastructure elements). Using a user interface in communication with the resource activity planning system 32, the user can plan for an activity to be conducted in association with an infrastructure element and budget for the costs of such activity.

With an infrastructure activity plan, construction of an infrastructure element can be planned for and budgeted as illustrated at steps 156, 158, 160 and 162 of FIG. 6. When planning for the construction of an infrastructure element, non-spatial information for the infrastructure element is recorded at step 156 and 158 including the type of infrastructure element, allocated human and equipment resources, the budgeted cost, contractors allocated to the task (if any), and the planned date(s) for construction and completion. With the resource activity planning system 32 construction of entire infrastructure elements, or portions thereof, can be planned for and budgeted. Preferably, the resource activity planning system 32 also prompts the user to define the nature of the planned method of construction of the infrastructure element.

Inspection plans for infrastructure elements can be prepared as illustrated at steps 166 and 168 of FIG. 6. A user can create and update an inspection plan by interfacing with the resource activity planning system 32 via a user interface from one of user machines 14. Upon receiving a request from one of the user machines 14 the resource activity planning system 32 sends to the user machine 14 a form or forms for display and access by the user. With the forms displayed, the user can enter information identifying the type of inspection, the allocated human and equipment resources, the infrastructure element to be inspected, the planned date(s) for such inspection, and other information related to the inspection. The information entered in the completed forms is then transmitted by the user machine 14 to the resource activity planning system 32 which stores the inspection plan in the planned results information database 34.

Maintenance plans for infrastructure elements can also be prepared as illustrated at steps 172 and 174 of FIG. 6. For instance, with roads and road structures, maintenance activities include the clearing of road ditches and applying gravel, where necessary, to the road. With the resource activity planning system 32, such maintenance activities can be planned for and later tracked using the actual results tracking system 38.

A maintenance plan is prepared by accessing the resource activity planning system 32 and requesting the maintenance planning feature. Upon receiving such a request, the resource activity planning system 32 transmits one or more maintenance forms to the user at the requesting user machine 14 where such forms are displayed for completion. A maintenance form contains fields for associating information received from the user with certain aspects of the maintenance plan. For instance, a maintenance form includes fields for identifying the infrastructure element that is to receive maintenance, the nature of the maintenance to be carried out, the planned date for the maintenance activity, and other forms of maintenance information. Other data structures may also be provided to record the human and capital equipment resources assigned to the maintenance activity, the estimated cost of such maintenance, and the expected completion date. Once the maintenance plan is completed, it is transmitted to the resource activity planning system 32 which stores the submitted information into the planned results information database 34.

An infrastructure element can also be deactivated with the resource activity planning system 32 as illustrated at steps 178, 180 and 182 of FIG. 6. A deactivation plan is used to effectively disable a particular infrastructure element from being available within the natural resource management system 10 for planning harvesting and reclamation activities. Such deactivation may be permanent or temporary depending on the nature of the deactivation. For instance, an infrastructure element such as a road may be deactivated temporarily due to flooding or the deactivation of other related road structures such as a bridge associated with the road. Using the resource activity planning system 32, a user can also restrict the use of an infrastructure element within the resource activity planning system 32 without necessarily deactivating it.

Preferably, a deactivation plan will include one or more data structures identifying the one or more deactivation methods planned in association with the infrastructure element to be deactivated as well as the level of deactivation that is to occur (for example, temporary, semi-permanent, or permanent).

With an access control plan, a data structure is preferably included to identify the kind of access available to the infrastructure element after access control is implemented. For instance, with respect to roads and road structures, the planned access control type following the implementation of access control may be by four wheel drive vehicle, all terrain vehicle, walking, or by helicopter.

Plans that are prepared and stored with the resource activity planning system 32 are computer-readable representations of planned activities to be undertaken in association with the one or more defined geographic units that are being managed with the natural resource by the natural resource management system 10. The generation and storage of infrastructure activity plans, harvest plans, and post harvesting reclamation plans enable the natural resource management system 10 to track the progress of activities planned for in association with the natural resource and defined geographic units.

Planning Harvesting Activities

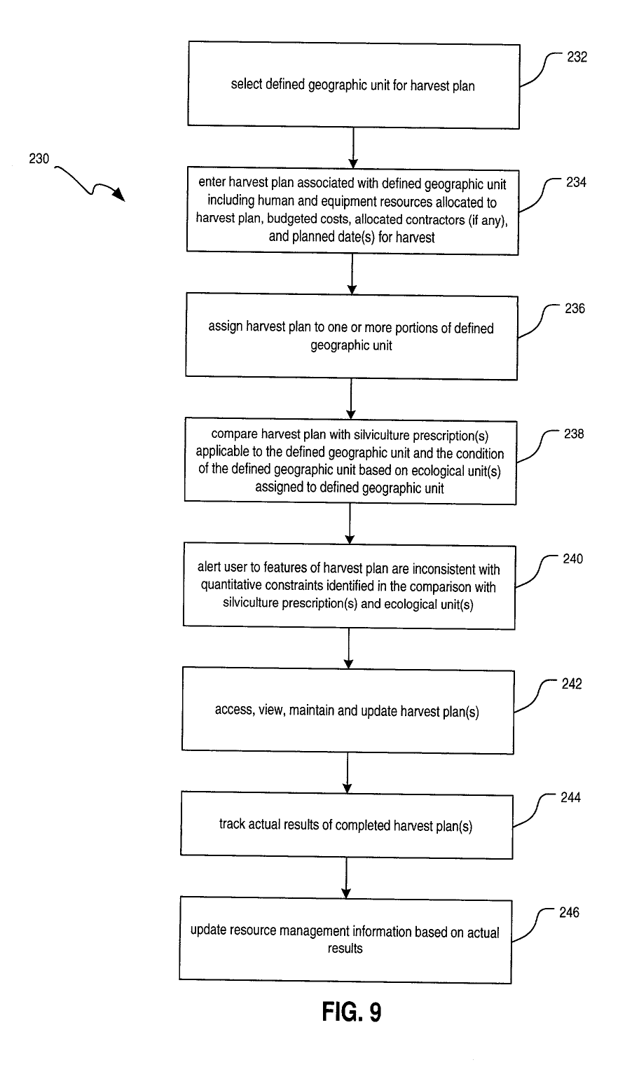

Referring to FIGS. 1 and 9, the resource activity planning system 32 provides a mechanism for, amongst other things, preparing one or more harvest plans. Harvest plans are used to prepare and manage the harvesting of the natural resource from one or more of the defined geographic units. Harvest plans set out the harvesting activities planned for in order to harvest the natural resource. Harvest plans are stored in the planned results information database 34.

Referring to FIGS. 1 and 9, the user selects at step 232 the defined geographic unit to which the harvest plan is associated. The harvest plan is prepared and entered at step 234 and assigned to one or more portions of the defined geographic unit selected at step 236. As part of planning one or more harvesting activities with the resource activity planning system 32, customer demands are identified along with the harvesting location(s), the harvesting method(s) that will be used, the harvesting schedule(s), the delivery location(s), as well as personnel, equipment and contractor resources (if any) that will be relied upon to perform the harvesting. Harvest plans contain spatial and non-spatial information tying harvesting to defined geographic units. This allows for the integration of harvesting with other management activities such as infrastructure activities and post-harvesting reclamation activities.

In the context of forestry, harvesting activities which can be planned for include felling, bucking, yarding, loading, and hauling. Felling represents a process of cutting down standing timber. Bucking represents a process of then cutting the timber into specific lengths for yarding and hauling. Yarding refers to hauling of felled timber to a landing or temporary storage site. Yarding methods include cable yarding, ground skidding, and aerial methods such as helicopter and balloon yarding. Loading is a process that loads the timber from a landing or temporary storage site onto trucks or other transportation vehicles. Hauling is the movement of timber from a landing or a temporary storage site to another inventory location. Examples of inventory locations are manufacturing sites, sorting sites, and storage sites.

When planning for the harvesting of a timber resource, one or more techniques (harvesting methods) for logging a stand of timber within the defined geographic unit(s) can be identified using the resource activity planning system 32. Examples of harvest methods for forestry include conventional harvesting, cable harvesting, and helicopter harvesting. Conventional harvesting usually refers to ground based logging techniques, which is any combination of mechanical or hand falling and rubber tired or tracked skidding equipment. A skidder is a large vehicle which drags logs from where they are felled to a road or landing. Some areas such as steep slopes can only be harvested using other methods such as cable harvesting or helicopter harvesting. Cable logging or harvesting is a yarding system employing winches, blocks, and cables.

Preferably, when a harvest plan is prepared it is compared at step 238 with the silviculture prescription(s) applicable to the defined geographic unit concerned and with the current condition of the defined geographic unit as defined by the ecological unit(s) assigned to the defined geographic unit. This comparison is performed by the resource activity planning system 32 for quantitative constraints available in the silviculture prescription(s) and the ecological unit(s). In general, the ecological unit(s) recorded for the defined geographic unit provide the current ecological condition of the defined geographic unit. Meanwhile, the silviculture prescription(s) associated with the defined geographic unit provide the regulatory guidelines which provide a minimum threshold at or above which the ecological unit(s) is (are) to be maintained during resource activity planning and execution or is (are) to be restored to with post-harvesting reclamation planning. If the resource activity planning system 32 identifies inconsistencies between the harvest plan and quantitative constraints identified in the comparison with the silviculture prescription(s) and ecological unit(s) associated with the defined geographic unit concerned, the user is alerted at step 240. In one variation, when preparing a harvest plan, the resource activity planning system 32 provides a user with a list of silviculture prescriptions and ecological units associated with with the defined geographic unit for which the harvest plan is being prepared. The list is displayed on the user's user interface and can be used to quickly access and review the silviculture prescriptions and ecological units so that the user can verify qualitative aspects of the silviculture prescriptions are being met.

Planning Post-Harvesting Reclamation

Referring to FIGS. 1 and 4, a plan for post-harvesting reclamation activities is prepared to support planning for reclamation activities associated with the defined geographic units within which the natural resource has been harvested. In this specification, “reclamation” refers to activities for the renewal or regeneration of the natural resource or the defined geographic unit(s), which have been subject to the infrastructure management or harvesting. Post-harvest reclamation plans that are prepared using the resource activity planning system 32 are stored and maintained within the planned results information database 34. Planned results can also be retrieved and updated using the resource activity planning system 32.

A plan for a post-harvesting reclamation activity is prepared by accessing the resource activity planning system 32 and requesting the post-harvesting reclamation form desired. Such requests are made via a user machine (14). Upon receiving such a request, the resource activity planning system 32 transmits the requested post-harvesting reclamation form(s) to the user at the requesting user machine (14) where such computer-implemented form(s) is (are) displayed for completion. A post-harvesting reclamation form contains fields for associating information received from the user with the post-harvesting reclamation plan. Once the post-harvesting reclamation plan is completed, it is transmitted to the resource activity planning system 32 which stores the submitted information in the planned results information database 34. Preferably, the resource activity planning system 32 is capable of receiving and storing spatial information for each planned post-harvest reclamation activity so that such spatial information can be used to overlay the planned activity on a digitized map for the defined geographic unit(s) involved.

Where the natural resource under management is renewable, such as with a timber resource, the post-harvesting reclamation activities include restoring in whole or in part the natural resource so that it can be re-harvested in the future. As well, other post-harvesting reclamation activities can be planned for with the resource activity planning system 32 and managed whether or not the natural resource is renewable or to be re-harvested. For instance, ecological activities may be planned for and managed so that management of the natural resource is carried out in a manner which conforms with regulatory constraints such as those managed by the regulatory constraint management system 24.

In the context of forestry, post-harvest reclamation activities include silviculture management. There are various activities that occur with respect to silviculture that need to be planned with the resource activity planning system 32 and for which progress needs to be tracked using the actual results tracking system 38. In forestry, silviculture activity groupings in need of planning include activities to prepare the site for planting (site preparation), activities to plant the site (planting), activities to apply silviculture treatments to the site after planting (treatments), and activities to access the status of the site before and after planting (surveys). In addition, a plan for post-harvest reclamation preferably complies with regulatory constraints such as the silviculture prescription(s) managed by the resource constraint management system 24 for the defined geographic unit concerned. Preferably, compliance with the silviculture prescription(s) is assessed by the resource activity planning system 32 by comparison with the current condition of ecological unit(s) associated with the defined geographic unit concerned. Users are notified by the resource activity planning system 32 if a plan for post-harvesting reclamation does not comply with quantitative constraints of the silviculture prescription(s). Users may view both quantitative and qualitative constraints stored by the resource management information system 18 to plan for and to verify compliance.

A post-harvesting reclamation plan for site preparation includes one or more data structures for identifying the site preparation activity, the area within the defined geographic unit that is to be subject to the site preparation activity, the planned date(s) for the site preparation activity, the budgeted cost for the site preparation activity and the nature of the planned site preparation activity. Examples of site preparation activities include burning the area to remove debris or piling the debris in rows.

A post-harvesting reclamation plan for planting the site includes one or more data structures for identifying a variety of attributes including a user defined planned planting activity, a total area to be planted within a defined geographic unit under this plan, a planned date(s) for the planting activity, a planned season for the planting activity, a set of one or more species of trees to be planted in the defined geographic unit, and a number of trees to be planted for each species. Such a plan also preferably includes a planned seed lot and a planned seedling request. Seed lots contain information about the seeds that are collected for planting purposes. Each seed lot contains the specific species of the seed as well as genetic information about the seed, what elevations the seed will grow, where the seeds were collected, and who owns the seed. A seedling request is a way of tying seed lots to stock and nursery information. Seed lots are grown at various nurseries under stock types. A stock type is a seedling of a specific size as defined by the physical characteristics of the container in which it is grown, and by its age in growing seasons. For each request the number of trees can be identified as well as costs for seed, growing, storage, and transport.

A post-harvesting reclamation plan for treatment (a treatment activity) includes one or more data structures for identifying a planned treatment activity, a total area to be treated in a defined geographic unit, a planned schedule for the treatment activity, a budget for the treatment activity, one or more species that are being targeted for the treatment activity, a chemical or chemicals to be used for the treatment activity, if applicable. Examples of treatment activities include brushing, spacing, fertilizing, and pruning. Brushing activities are the manual, mechanical, ground chemical, aerial chemical or biological/livestock activities used to control competing vegetation where competing vegetation may be a problem to seedling survival or performance.

A post-harvesting reclamation plan for surveying the site includes one or more data structures for identifying a planned survey activity, a total area to be surveyed within a defined geographic unit, a planned date or dates for the planned survey and a budget for the survey. A survey is an examination of a defined geographic unit for the purpose of providing information on how the site and stand are progressing relative to the prescribed management objectives. Example surveys include brushing surveys, free growing surveys, and stocking surveys. Brushing surveys assess the impact of brushing activities. The free growing survey is used to determine the number of preferred and acceptable, free growing trees per hectare present on a defined geographic unit. Stocking surveys are used to determine the stocking status of a defined geographic unit by describing both the preferred and acceptable well-spaced and total trees.

User-Definable Attributes for Plans

With the resource activity planning system 32 a user may also define user definable attributes for a resource activity plan so that the nature of the information being managed with respect to any or all of the plans can be extended to the particular needs of the user. This provides a user with the flexibility to capture and track certain default information about resource activity plans as well as user-defined attributes associated with those plans.

Verification of Resource Activity Plans

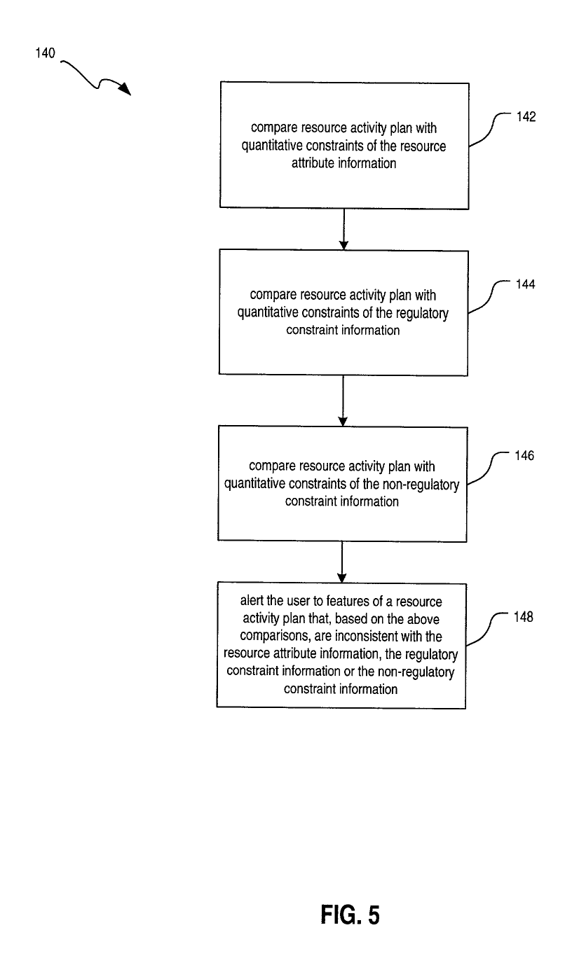

Referring to FIGS. 1 and 5, as illustrated generally at 140 the resource activity planning system 32 preferably notifies the user when a resource activity plan does not comply with constraints set by the resource management information. The resource activity planning system 32 compares quantitative features of a resource activity plan against corresponding quantitative features of resource management information stored and managed by the resource management information system 18. For example, the resource activity planning system 32 compares a resource activity plan against the quantity and species of timber planned for harvesting in a defined geographic unit. As another example, resource activity plans for harvesting are compared against regulatory constraints such as reserve areas defined in the regulatory constraint information database 26 as being areas where harvesting is not permitted or where it is permitted on only a limited basis in accordance with government regulatory requirements defined and stored in the regulatory constraint information database 26.

In the first embodiment, the resource activity planning system 32 compares at step 142 quantitative measures of a resource activity plan with quantitative constraints stored in the resource attribute information database 22. At step 144 the resource activity planning system 32 compares quantitative measures of the resource activity plan with quantitative constraints stored in the regulatory constraint information database 26. At step 146 the resource activity planning system 32 compares quantitative measures of the resource activity plan with quantitative constraints stored in the non-regulatory constraint information database 30. At step 148 the resource activity planning system 32 alerts the user to features of the resource activity plan identified from the above comparisons as inconsistent with quantitative constraints specified for the defined geographic unit in question by the resource attribute information, the regulatory constraint information and the non-regulatory constraint information.

Resource Activity Management System

Planned results are used by the resource activity management system 36 to assist in managing the execution of planned activities associated with the defined geographic units. The resource activity management system 36 also provides an interface by which users can view planned results and progress reports associated with actual results being tracked by the actual results tracking system 38.

Planned for activities stored in the planned results information database 34 are monitored by users via one or more user machines connected directly or indirectly to the natural resource management system 10. The resource activity management system 36 is used to compare planned results from the planned results information database 34 with actual results received from the user by the resource activity management system 36. For instance, infrastructure activities planned for using the resource activity planning system 32 are preferably monitored by the resource activity management system 36, with the actual results from the execution of such plans being stored by the actual results tracking system 38. The resource activity management system 36 allows users to compare planned results from the planned results information database 34 with actual results stored in the actual results information database 40. With the resource activity management system 36, the progress of planned activities can be monitored and plans stored in the planned results information database 34 may be dynamically updated by a user based on comparisons between planned results with actual results that are stored and updated in the actual results information database 40.

Preferably, with the resource activity management system 36 available contractors and contractor equipment can be tracked and assigned to appropriate activities. Other human resources and capital equipment may also be managed by the resource activity management system 36. As well, other information concerning the terms of availability of such human and capital resources may also be tracked and maintained so that appropriate activities can be planned for and appropriate budgets maintained.

In another variation, the resource activity management system 36 (or alternatively the resource activity planning system 32) preferably also notifies users of changes in conditions of resource management information that have an impact on related resource activity plans stored in the planned results information database 34. In this case, changes in conditions to the resource management information stored and managed by the resource management information system 18 are monitored by the resource activity planning system 32 for changes that have an impact on resource activity plans stored in the planned results information database 34. The resource activity management system 36 monitors the planned results information database 34 for any recorded indication that one or more of the resource activity plans may have been impacted by changes to the resource management information such that a resource activity plan or plans cannot be carried out as originally defined using the resource activity planning system 32. Resource activity plans affected by changes to the resource management information are flagged by the resource activity planning system 32. The resource activity management system 36 notifies a user identified with a resource activity plan as being the contact administrator that the resource activity plan has been impacted. This can be done, for instance, by sending an automated e-mail to the user where an e-mail address has been recorded as the contact address when a resource activity plan has been generated and stored in the planned results information database 34. An example of a change in the condition of resource management information that would have an impact on one or more resource activity plans is where there has been an interruption of availability of infrastructure elements designated in one or more resource activity plans as being used to carry out one or more of the activities recorded as part of the resource activity plan concerned. This could arise, for instance, where an infrastructure element such as a bridge has been temporarily or permanently deactivated or where an infrastructure element is undergoing maintenance.

In addition, the resource activity management system 36 supports a plurality of views of the planned results information database 34 and of the resource management information stored in the resource attribute information database 22, the regulatory constraint information database 26 and the non-regulatory constraint information database 30. A user is able to access many views of the defined geographic units, the natural resource, and the activities planned for and underway. For instance, a user can view the status of all or a subset of all infrastructure elements of a certain type or of a certain characteristic, resource activity plans of a certain type or having a certain characteristic, the allocation of certain human and equipment resources to activities planned for within the natural resource management system 10 as well as other types of information managed therein. As an example, a user can request that the resource activity management system 36 (or another component of the natural resource management system 10) provide a list of all plans of a particular type, for example, all construction plans, that are to be carried out within a certain period of time on one or more of the defined geographic units. As another example, a user may retrieve a list of all infrastructure elements of a certain type (for instance roads) associated with a defined geographic unit which have any type of planned activities associated with them. As another example, a user may view a list of infrastructure elements or all infrastructure elements of a certain type, that are scheduled for maintenance of one sort or the other, within a defined geographic unit. A user may also view a list of all infrastructure elements which have not been inspected or received any maintenance within a certain period of time. While these are just a few of the examples of the many views that a user has of the resource activity plans and other resource management information stored and managed by the natural resource management system 10, they illustrate the flexibility and control a user has over the management of a natural resource for which resource management information, resource activity plans, and other information have been captured within the natural resource management system 10.

Actual Results Tracking

The resource activity management system 36 communicates progress information about resource activity progress to the actual results tracking system 38 which stores such progress information as actual results within the actual results information database 40. Actual results from the actual results information database 40 is fed back by the natural resource management system 10 to the resource activity management system 36 and the resource activity planning system 32 in order to improve the quality of resource activity management and resource activity planning. Actual results stored in the actual results information database 40 include results of contractor resource activity, non-contractor resource activity, and updates pertaining to the resource management information for the natural resource such as resource product inventory within the defined geographic units. Actual results associated with planned activities are also fed back to the resource management information system 18 which dynamically updates resource management information to reflect changes arising from the actual results.

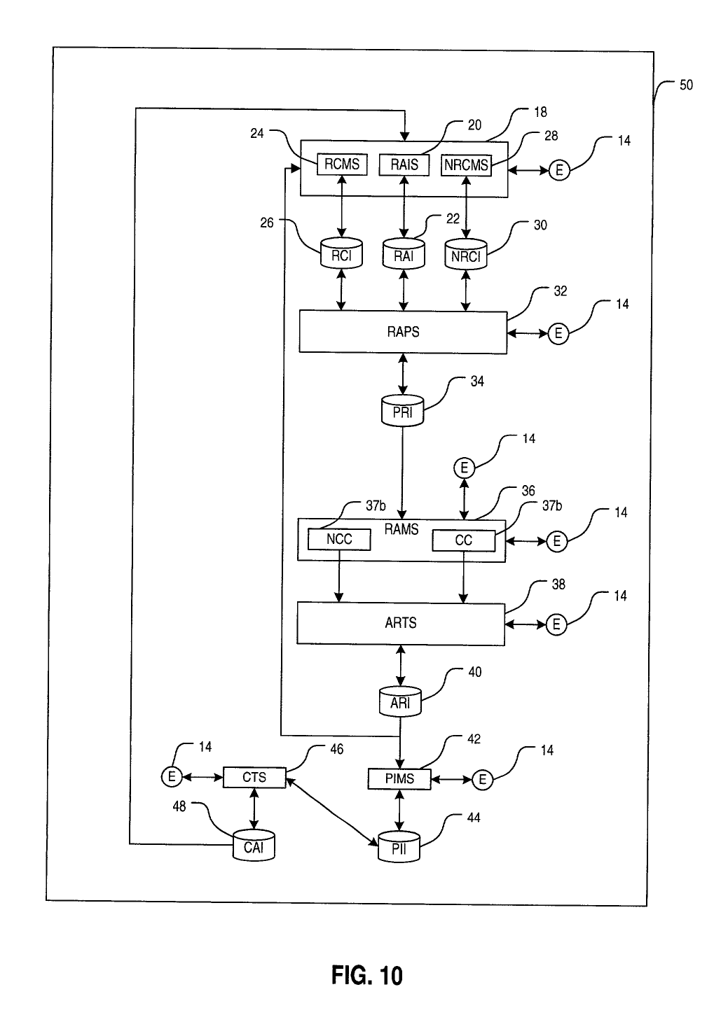

Referring to FIG. 10, a second embodiment of a natural resource management system in accordance with the present invention is shown generally at 50. The natural resource management system 50 is substantially similar to the natural resource management system 10 described above and shown in FIGS. 1 to 9. In addition, the natural resource management system 50 includes a product inventory management system 42 and a customer tracking system 46 for improved natural resource management and for extended integration of the supply chain management over the natural resource.

Referring to FIG. 10, the actual results information stored by the actual results tracking system 38 can affect existing and future planning of the products being harvested. An example of an output product in the context of forestry are the logs which are harvested from the timber resource. Consequently, actual results information in FIG. 10 is also fed to the product inventory management system 42 which manages a product inventory information database 44. The product inventory management system 42 is used to store in the product inventory information database 44 harvested inventory movement results received from the actual results tracking system 38. Harvest inventory movements results are recorded to track the location of harvested natural resource (product inventory) in transit from harvesting locations within defined geographic units to manufacturing sites, sorting sites and storage sites. The product inventory management system 42 is used to manage product inventory movements and stores such product inventory movement information within the product inventory information database 44.

Product inventory movement information is also used by a customer tracking system 46 which maintains a customer information database 48. The customer tracking system 46 is used to store and track customer information and requirements within the customer information database 48. Delivery dates, volumes, product type, and other delivery requirements are also stored within the customer information database 48 and maintained by the customer tracking system 46. In the embodiment illustrated, requirements for internal and external parties (or “customers”) are tracked by the customer tracking system 46. Internal customers represent sections, divisions or departments within the organization managing the natural resource with the natural resource management system 50 (the “operating organization”). External customers represent third parties such as intended purchasers or users of the harvested natural resource, government bodies with regulatory authority over natural resource management activities. In the context of forestry, the customer tracking system 46 tracks and manages requirements of external customers based on external agreements such as purchase agreements, trade agreements and the like. The customer tracking system 46 also tracks and manages requirements of internal customers based on, for example, arrangements defined by internal transfer agreements and delivery agreements. An internal transfer agreement is used to manage the transfer of the natural resource (the timber resource) from one location within the operating organization to another location within the operating organization, including the transfer schedule, quantity(ies) and destination of the natural resource. An internal delivery agreement is used to manage the movement within the operating organization and its subsidiaries of the timber resource to and from mills. Management of these internal arrangements enable the natural resource management system 50 to manage the transfer and delivery between divisions, subsidiaries or the like of the operating organization at intermediary stages of processing, from, for example, a bush location, storage site or mill yard.

With the natural resource management system 50, product inventory movements can be monitored by the product inventory management system 42 to verify that actual product inventory that is in the process of being harvested for delivery will be delivered to customers in accordance with customer delivery requirements stored within the customer information database 48. In the event actual product inventory movements will not satisfy customer delivery requirements, the natural resource management system 50 preferably notifies an operator (or user) of which delivery requirements will not be met under current conditions and which planned activities are not being met resulting in deficiencies. With such information available to an operator, the natural resource management system 50 can be used to modify plans so that actual results are adjusted to meet customer delivery requirements. As well, the natural resource management system 50 provides an operator (or user) with an opportunity to modify customer delivery requirements to meet current product inventory movements provided such customer delivery requirements can be renegotiated.

While specific embodiments of the invention have been described and illustrated, such embodiments should be considered illustrative of the invention only and not as limiting the invention as construed in accordance with the accompanying claims.

What is claimed is:

1. A computer-implemented method of integrated natural resource management comprising:
a) storing and managing resource management information associated with defined geographic units in a database, including storing spatial and non-spatial information associated with the defined geographic units;
b) preparing resource activity plans based on the resource management information for use in managing a natural resource within the defined geographic units;
c) tracking actual results of managing the natural resource according to the resource activity plans for use in updating the resource management information; and
d) updating the resource management information based on the tracking of actual results.

2. The method of claim 1, wherein preparing resource activity plans further comprises notifying a user when a resource activity plan is affected by updates to the resource management information.

3. The method of claim 1, wherein the resource management information stored further comprises constraint information based on laws and regulations applicable to the defined geographic units and wherein the said constraint information is relied upon in the preparation of resource activity plans.

4. The method of claim 1, wherein the resource management information stored further comprises constraint information based on customer orders for the natural resource or for products derived from the natural resource and wherein the said constraint information is relied upon in the preparation of resource activity plans.

5. The method of claim 1, further comprising notifying a user when changes in conditions of the resource management information have an impact on resource activity plans.

6. The method of claim 5, wherein the resource management information stored further comprises feedback from actual results of managing the natural resource according to the resource activity plans.

7. The method of claim 1, wherein preparing resource activity plans further comprises preparing a plan for harvesting the natural resource within the geographic units.

8. The method of claim 7, wherein preparing resource activity plans further comprises preparing a plan for developing infrastructure for use in supporting harvesting the natural resource.

9. The method of claim 7, wherein preparing resource activity plans further comprises preparing a plan for maintaining and deactivating infrastructure for use in supporting harvesting the natural resource.

10. The method of claim 7, wherein preparing resource activity plans further comprises preparing a plan for reclamation of the defined geographic units following the receipt of update information pertaining to the effects of harvesting the natural resource.

11. The method of claim 10, wherein preparing resource activity plans further comprises preparing a silviculture related plan.

12. The method of claim 1, further comprising notifying a user when one or more of the resource activity plans do not comply with constraints set by the resource management information.

13. The method of claim 12, wherein notifying further comprises notifying the user of features of one or more resource activity plans identified as inconsistent with quantitative constraints specified for the defined geographic unit in question by resource attribute information and regulatory constraint information.

14. The method of claim 12, further comprising verifying that the resource activity plans comply with one or more silviculture prescriptions associated with the defined geographic units.

15. The method of claim 14, further comprising verifying that the resource activity plans associated with at least one of the defined geographic units comply with a silviculture prescription associated with the at least one of the defined geographic units, including comparing one or more quantitative constraints in the silviculture prescription with ecological data stored in the database for the at least one of the defined geographic units.

16. A computer-implemented system for integrated natural resource management comprising:
a) means for storing and managing resource management information associated with defined geographic units in a database, comprising means for storing spatial information and non-spatial information associated with the defined geographic units;
b) means for preparing resource activity plans based on the resource management information for use in managing a natural resource within the defined geographic units;
c) means for tracking actual results of managing the natural resource according to the resource activity plans for use in updating the resource management information; and
d) means for updating the resource management information based on the tracking of actual results.

17. The system of claim 16, further comprising means for notifying a user when a resource activity plan is affected by updates to the resource management information.

18. The system of claim 16, wherein the resource management information stored further comprises regulatory constraint information applicable to the defined geographic units and wherein the said regulatory constraint information is relied upon by the means for preparation of resource activity plans to verify compliance with such regulatory constraint information by such resource activity plans.

19. The system of claim 16, wherein the resource management information stored further comprises constraint information based on customer orders for the natural resource or for products derived from the natural resource and wherein the said constraint information is relied upon by the means for preparation of resource activity plans.

20. The system of claim 16, further comprising means for notifying a user when one or more of the resource activity plans do not comply with constraints set by the resource management information.

21. The system of claim 20, where the means for notifying further comprises means for notifying the user of features of one or more resource activity plans identified as inconsistent with quantitative constraints specified for the defined geographic unit in question by resource attribute information and regulatory constraint information.

22. The system of claim 16, wherein the means for preparing resource activity plans further comprises means for preparing a plan for harvesting the natural resource.

23. The system of claim 22, wherein the means for preparing resource activity plans further comprises means for preparing a plan for developing infrastructure elements for use in supporting harvesting of the natural resource.

24. The system of claim 23, wherein the means for preparing resource activity plans further comprises means for preparing a plan for maintaining and deactivating infrastructure elements for use in supporting harvesting the natural resource.

25. The system of claim 22, wherein the means for preparing resource activity plans further comprises means for preparing a plan for post-harvest reclamation of at least one of the defined geographic units.

26. The system of claim 16, wherein the means for preparing resource activity plans further comprises means for preparing a silviculture related plan.

27. A computer-implemented system for integrated natural resource management comprising:
a) a resource management information system adapted to store and manage resource management information associated with defined geographic units in a database, including spatial information and non-spatial information associated with the defined geographic units;
b) a resource activity planning system adapted to prepare resource activity plans based on the resource management information for use in managing a natural resource within the defined geographic units;
c) an actual results tracking system adapted to track actual results of managing the natural resource according to the resource activity plans for use in updating the resource management information; and
d) a product inventory management system adapted to store harvested inventory movement results received from the actual results tracking system;
wherein the resource management information system is adapted to update the resource management information based on the tracking of actual results by the actual results tracking system.

28. The system of claim 27, further comprising a resource activity management system adapted to provide users with views of the resource activity plans and adapted to compare the resource activity plans with the actual results tracked by the actual results tracking system.

29. The system of claim 28, further comprising a customer tracking system adapted to store and track customer information and requirements including delivery requirements, wherein product inventory movements can be monitored by the product inventory management system to verify that actual product inventory that is in the process of being harvested for delivery will be delivered to customers in accordance with delivery requirements of such customers.

30. A computer-implemented method for use in a computerized natural resource management system, the method comprising:
a) planning for developing and maintaining infrastructure elements for use in extracting a natural resource from a defined geographic unit;
b) planning for the extraction and delivery of the natural resource from the defined geographic unit using the infrastructure elements;
c) tracking results of actual extraction and delivery of the natural resource from the defined geographic unit; and
d) planning for reclamation of the natural resource within the defined geographic unit.

31. The method of claim 30, wherein the planning of the development and maintenance of the infrastructure elements further comprises:
a) preparing a schedule for constructing the infrastructure elements; and
b) planning maintenance activities associated with the infrastructure elements and monitoring the progress of said maintenance activities.

32. The method of claim 30, wherein the planning of the development and maintenance of the infrastructure elements further comprises:
a) tracking construction, inspection and deactivation of the infrastructure element associated with the defined geographic unit.

33. A computer-implemented method of natural resource management comprising:
a) preparing an operational plan for extracting a natural resource from a plurality of defined geographic units and for delivering the extracted natural resource to at least one processing facility, said plurality of defined geographic units making up an operational area which is subject to the operational plan;
b) committing the operational plan for use in a resource management system to manage the harvesting and delivery of the natural resource; and
c) verifying that the operational plan does not conflict with any other operational plans committed to the resource management system that also involve plans for extracting the natural resource within one or more of said plurality of defined geographic units.

34. The method of claim 33, wherein preparing further comprises specifying harvesting methods, resource processing destinations, and harvesting dates.

35. The method of claim 33, wherein the preparation of the operational plan further comprises identifying said plurality of defined geographic units by specifying filtering criteria in order to limit said plurality of defined geographic units to a subset thereof based on the filtering criteria.

36. A computer-implemented method of integrated natural resource management comprising:
a) preparing logging schedules for harvesting a timber resource from a plurality of defined geographic units, each defined geographic unit having spatial and non-spatial inventory attributes;
b) planning delivery destinations for the timber resource to be harvested from the defined geographic units;
c) planning harvesting methods for the timber resource;
d) tracking actual harvesting and delivery of the timber resource from the defined geographic units; and
e) planning for renewal of the timber resource within the defined geographic units and tracking actual renewal activities with respect to the timber resource.
